(19) United States
(12) Patent Application Publication
(10) Pub. No.: US 2014/0274060 A1
(43) Pub. Date: Sep. 18, 2014

(54) COMMUNICATION SYSTEM, RADIO COMMUNICATION NODE, AND COMMUNICATION CONTROL METHOD

(71) Applicant: Masato Fujishiro, Yokohama-shi (JP)

(72) Inventor: Masato Fujishiro, Yokohama-shi (JP)

(73) Assignee: KYOCERA CORPORATION, Kyoto (JP)

(21) Appl. No.: 14/355,953

(22) PCT Filed: Nov. 8, 2011
(86) PCT No.: PCT/JP2011/075753

§ 371 Date: May 2, 2014

(51) Int. Cl. H04W 8/14; H04W 36/08

(52) U.S. Cl. CPC H04W 8/14; H04W 36/08
USPC 455/436

(57) ABSTRACT

A source node transmits node information for UE mobility control, and a target node receives the node information. The node information includes: a Node Type, which indicates whether or not the source node is mobile: an M-RN Group ID, which, when the source node is a mobile RN, indicates, the M-RN group to which the RN belongs; and a Movement Condition, which indicates the mobility status of the source node.

### TECHNICAL FIELD

The present invention relates to a communication system for mobility control of a user equipment, a radio communication node, and a communication control method.

### BACKGROUND ART

The LTE (Long Term Evolution)-Advance, which is next generation radio communication standard, is under development and standardization by the 3GPP (3rd Generation Partnership Project).

A Mobile Relay Node (Mobile Relay Node: M-RN) is raised as a candidate of next expansion functions of LTE Advanced (e.g. Non-Patent Document 1).

LTE-Advance has already supported Relay Node (Relay Node: RN), and the RN has equivalent functions to a base station (eNode B: eNB).

### PRIOR ART DOCUMENT

### Non-Patent Document

Non-patent Document 1: 3GPP RP-110894 “New Study Item Proposal: Mobile Relay for E-UTRA”, 2011 May.
Non-patent Document 2: 3GPP TS36.300 “Evolved Universal Terrestrial Radio Access (E-UTRA) and Evolved Universal Terrestrial Radio Access Network (E-UTRAN); Overall description; Stage2 (Release 10)”, 2010 December.

### SUMMARY OF THE INVENTION

### Problem Solved by the Invention

However, currently, a geographical movement of a radio communication node, that is E-UTRAN Node (i.e. eNB and RN), included E-UTRAN (Evolved Universal Terrestrial Radio Access Network), is not considered.

Accordingly, when M-RN is introduced, the mobility control (i.e. handover control and cell reselection) of a user equipment (user equipment: UE) may not be properly executed.

Therefore, this invention is provide a communication system, a radio communication node and communication control method, which can execute the mobility control properly, when M-RN is introduced

### The Means to Solve the Problem

In order to solve the problem described above, this invention has the following features.

A communication system provided with a user equipment (e.g. UE300), a radio access network being capable of communicating with the user equipment (e.g. E-UTRAN10), and the radio access network including a mobile radio communication node (e.g.M-RN200), the communication system comprising: a first radio communication node included in the radio access network (e.g. eNB100 or RN200), a second radio communication node included in the radio access network (e.g. eNB100 or RN200), the first radio communication node transmits node information for a mobility control of the user equipment (e.g. Mobile Node Information), the second radio communication node receives the node information, wherein the node information includes at least one of information indicating whether the first radio communication node is mobile or not, information indicating a mobile radio communication group, to which the first radio communication node belongs, when the first radio communication node is mobile and information indicating a mobility status of the first radio communication node.

Another feature of the communication system according to the present invention, the communication system further comprising: a core network connected to the radio access network, wherein the second radio communication node receives the node information from the first radio communication node via the core network.

Another feature of the communication system according to the present invention, the communication system further comprising: the first communication node transmits a request for handover of the user equipment, accommodated to the first radio communication node, the second radio communication node executes a decision whether the request received is admitted or not, wherein the node information is used for the decision at the second radio communication node.

Another feature of the communication system according to the present invention, the communication system further comprising: when the second radio communication node receives a report regarding a measurement result of the received signal status at the user equipment from the user equipment accommodated by the second radio communication node, the second radio communication node executes a decision of handover based on the report received, wherein the node information is used for the decision at the second radio communication node.

Another feature of the communication system according to the present invention, the communication system further comprising: the second radio communication node transmits information for a measurement control for measuring a received signal status at the user equipment to the user equipment accommodated by the second radio communication node, wherein the node information is used for the measurement control at the second radio communication node.

Another feature of the communication system according to the present invention, the communication system further comprising: the second radio communication node transmits information for a cell reselection control by broadcast, wherein, the node information is used for the cell reselection control at the second radio communication node.

A radio communication node in a communication system, the communication system provided with a user equipment, a radio access network being capable of communicating with the user equipment, and the radio access network including a mobile radio communication node, the radio communication node comprising: a transmission unit configured to transmit node information for a mobility control of the user equipment to another radio communication node included in the radio access network, wherein the node information includes at least one of information indicating whether the radio communication node is mobile or not, information indicating a mobile radio communication group, to which the radio communication node belongs, when the radio communication node is mobile and information indicating a mobility status of the radio communication node.

A radio communication node in a communication system, the communication system provided with a user equipment, a radio access network being capable of communicating with the user equipment, and the radio access network including a mobile radio communication node, the radio communication node comprising: a receiving unit configured to receive node information transmitted by another radio communication node included in the radio access network, and the node information is for a mobility control of the user equipment, wherein the node information includes at least one of information indicating whether the another radio communication node is mobile or not, information indicating a mobile radio communication group, to which the another radio communication node belongs, when the another radio communication node is mobile and information indicating a mobility status of the another radio communication node.

A communication control method in a communication system, the communication system provided with a user equipment, a radio access network being capable of communicating with the user equipment, and the radio access network including a mobile radio communication node, the communication system comprising: a step of transmitting, by a first radio communication node included in the radio access network, node information for a mobility control of the user equipment, a step of receiving, by the second radio communication node included in the radio access network, the node information, wherein the node information includes at least one of information indicating whether the first radio communication node is mobile or not, information indicating a mobile radio communication group, to which the first radio communication node belongs, when the first radio communication node is mobile and information indicating a mobility status of the first radio communication node.

### Effect of Inventions

According to this invention, a communication system, a radio communication node and communication control method, which executes a user equipment mobility control properly, can be provided, when M-RN is introduced.

### BRIEF EXPLANATION OF DRAWINGS

FIG. 1 is a view showing a configuration of an overall communication system according to first to fourth embodiments.

FIG. 2 is a block diagram showing eNB according to the first to fourth embodiments.

FIG. 3 is a block diagram showing a relay node according to the first to fourth embodiments.

FIG. 4 shows a status of a mobile object such as train (or a bus) set M-RN passing near eNB.

FIG. 5 is an operation sequence diagram for describing handover procedure according to the first embodiment.

FIG. 6 is a flow chart for describing a decision of admitting handover according to the first embodiment.

FIG. 7 shows a message configuration of HANDOVER REQUEST according to the first embodiment.

FIG. 8 shows a configuration of Mobile Node Information IE according to the first embodiment.

FIG. 9 is an operation sequence diagram for describing handover procedure according to an example modification of the first embodiment.

FIG. 10 shows a message configuration of HANDOVER REQUEST according to the example modification of the first embodiment.

FIG. 11 shows a message configuration of HANDOVER REQUEST according to the example modification of the first embodiment.

FIG. 12 is an operation sequence diagram for describing handover procedure according to the second embodiment.

FIG. 13 is a flow chart for describing a decision of handover according to the second embodiment.

FIG. 14 is a message configuration of X2 SETUP according to the second to the fourth embodiment.

FIG. 15 is a message configuration of ENB CONFIGURATION UPDATE according to the second to the fourth embodiment.

FIG. 16 is an operation sequence diagram for describing handover procedure according to a first example modification of the second embodiment.

FIG. 17 is an operation sequence diagram for describing handover procedure according to a second example modification of the second embodiment.

FIG. 18 is a message configuration of eNB CONFIGURATION TRANSFER according to the second example modification of the second embodiment.

FIG. 19 is a message configuration of MME CONFIGURATION TRANSFER according to the second example modification of the second embodiment.

FIG. 20 is an operation sequence diagram for describing handover procedure according to the third embodiment.

FIG. 21 is a flow chart for describing a decision flow for Black List modification according to the third to the fourth embodiment.

FIG. 22 is an operation sequence diagram for describing cell reselection procedure according to the fourth embodiment.

FIG. 23 shows a configuration of Mobile Node Information IE according to the other embodiments.

### DESCRIPTION OF THE EMBODIMENTS

First to fourth embodiments as well as other embodiments of the present invention will be described with reference to the accompanying drawings. In the drawings related to the respective embodiments described below, identical or similar constituents will be denoted by identical or similar reference numerals.

### First Embodiment

FIG. 1 is the overall communication system configuration diagram according to this embodiment. The communication system according to this embodiment is configured based on LTE-Advance specified by 3GPP and supports M-RN.

As shown in FIG. 1, the communication system according to this embodiment includes eNB100, RN200, UE300, MME (Mobility Management Entity)/S-GW (Serving Gateway) 400.

eNB100 and RN200 configure E-UTRAN, which is LTE radio access network. Hereinafter, a radio communication node included in E-UTRAN10 (i.e. eNB100 and RN200) is referred to as “E-UTRAN Node” or “Node”, properly.

MME (Mobility Management Entity)/S-GW (Serving Gateway) 400 configures EPC20, which is a core network of LTE.

eNB100 is a fixed radio communication node and configured to execute radio communication with RN200 or UE300. eNB100, which executes radio communication with RN200, is referred to as a donor eNB (DeNB).

eNB100 communicates with neighbor other eNB100 via X2 interface, communicates with neighbor RN200 via X2 interface or S1 interface and communicates with MME/S-GW 400 via S1 interface. Furthermore, DeNB100-2 communicates with MME/S-GW 400 via S11.

eNB100 and RN200 form one cell or plural cells, which is the smallest unit of a radio communication area. eNB100 and RN200 always transmits a reference signal identifying cell via broadcast.

RN (or M-RN) 200 is a fixed (or mobile) radio communication node, is configured to execute radio communication with eNB100 (DeNB100-2) and with UE300. RN (or M-RN) 200 has an interface between RN200 and eNB100-2, which is similar to an interface between eNB100-2 and UE300 (Un interface). UE300 communicates with RN200, with a similar way to communicating with eNB100.

RN (or M-RN) 200 communicates with DeNB100-2 on X2 interface, on S1 interface and on Un interface.

UE 300 is mobile radio communication equipment owned by a user. UE300 access to a cell formed by eNB100 or a cell formed by RN200 and is accommodated to the cell. A status, UE executing a communication with a serving cell, is referred to as a connected status (RRC_CONNECTED). A status, UE is in standby status, is referred to as an idle status (RRC_IDLE).

UE300 switches from the serving cell to the best communication status cell. A switch in the connected status is referred to as handover. The handover is controlled by the serving cell (eNB100 or RN200). And a switch in the idle status is referred to as cell reselection.

UE300 measures a receiving signal status from the serving cell and neighbor cells, and transmits a report regarding measurement results to the serving cell. This report is referred to as Measurement Report. The receiving signal status is a reference signal receiving power (RSRP) or a reference signal receiving quality (RSRQ), for example.

MME manages the cell UE camping on, and is configured to execute various mobility management to UE300. S-GW is configured to execute forwarding control to user data sent and received by UE300.

Next, the configuration of eNB100 is explained. FIG. 2 is a block diagram of eNB100.

As described FIG. 2, eNB100 has an antena101, a radio communication unit110, a network communication unit120, a storage unit130 and a control unit140.

The antena101 is used for transmitting and receiving radio signals. The radio communication unit110 executes a radio communication conformed LTE physical layer specification. The radio communication unit110 is configured, for example, by a radio frequency (RF) circuit, a baseband (BB) circuit and so on, and transmits and receives radio signals via the antena101.

The network communication unit120 executes communication with other eNB100 on X2 interface, and executes communication with MME/S-GW400 on S1 interface (and S11 interface).

The storage unit130 is configured by memories, for example, memorizes various information of eNB100 control and so on. The control unit140 is configured by processors, for example, and controls various functions installed in eNB100. The control unit140 executes the mobility control (handover control and cell reselection control) of UE300. The mobility control is described in detail later.

Next, a configuration of RN200 is explained. FIG. 3 is a block diagram of RN200.

As described FIG. 3, RN200 has an antena201, a radio communication unit210, an antenna202, a radio communication unit220, GPS (Global Positioning System) receiving equipment230, a storage unit 240, and a control unit250.

However, RN200 does not need to have the GPS receiving equipment.

The antenna201 is used for sending and receiving radio signals to/from DeNB100-2. The radio communication unit 210 is configured by RF circuit, BB circuit and so on, for example, and executes the radio communication with DeNB100-2, via the antena201, conforming with LTE physical layer specification. The radio communication unit 110 communicates with DeNB100-2 on X2 interface, on S1 interface and on Un interface.

The antena202 is used for transmitting and receiving radio signals to/from UE300. The radio communication unit220 is configured by RF circuit, BB circuit and so on, for example, and executes the radio communication with UE200, via the antena201, conforming with LTE physical layer specification.

The GPS receiving equipment230 receives GPS signal and output location information indicating a geographical location of RN200 to the control unit250.

The storage unit240 is configured by memories, for example, memorizes various information of RN200 control and so on. The control unit250 is configured by processors, for example, and controls various functions installed in RN200. The control unit250 executes the mobility control (handover control and cell re selection control) of UE300. The mobility control is described in detail later.

And the control unit250 detects a mobility status of RN200 itself, based on the location information from GPS receiving equipment 230. Or the control unit250 counts the number of handover or the number of cell reselection in the radio communication unit210, and may detect the mobility status whether this counting number exceeds a certain number within a specified time period. Or the control unit250 may detect this status by notifying from other node or UE300.

Next, an operation environment of the communication system is explained. FIG. 4 shows a status that a mobile object such as the train (or the bus) passes by eNB100.

As shown in FIG. 4, M-RN200 (M-RN200-1 and M-RN200-2) is set in the mobile object and UE300-1 is accommodated by M-RN200-1 in the mobile object. M-RN200 is accommodated by DeNB100-2. And UE300-2 is accommodated by eNB100-1.

In a process of the mobile object approaching to eNB100 (eNB100-1 or DeNB100-2), UE300-1 executes handover from M-RN200-1 to eNB100. Immediately after a process of the mobile object departing from eNB100, UE300-1 executes handover from eNB100 to M-RN200-1. This phenomenon becomes notably, if a transmission power of eNB100 is larger than the transmission power of M-RN200.

And, a process of the mobile object approaching to UE300-2, UE300-2 executes handover from eNB100-1 to M-RN200. Immediately after a process of the mobile object departing from UE300-2, UE300-2 executes handover from M-RN200 to eNB100-1.

This type of back and forth phenomenon is referred to as Ping-pong handover, and consumes resource, wastefully. Furthermore, due to handover executions simultaneously by many UE, when many UE are accommodated by M-RN200, processes congested and handover failure incidence rate gets high.

In order to solve these problems, in this embodiment, Information indicating a mobility status of a source node (hereinafter, referred to as “Movement Condition”) is notified from a handover source E-UTRAN node (hereinafter, referred to as “Source Node”) to a handover candidate E-UTRAN node (hereinafter, referred to as “Target Node”). And, the target node declines to accept UE300, if at least one of the source node and the target node is in motion. As a result, Ping-pong handover described above is avoided.

On the other hand, if UE300-1 is moving toward M-RN200-2 when M-RN200 is in motion, handover from M-RN200-1 to M-RN200-2 should be admitted. Therefore, in this embodiment, M-RN200 group admitted handover (hereinafter, referred to as “M-RN Group”) is pre-set, and the source node notify the target node of M-RN Group ID for identifying M-RN Group. Then, the target node admits an admission of UE300, if M-RN Group ID of the source node and that of the target node is confirmed to be the same. On the contrary, it declines the admission of UE300, if M-RN Group ID of the source node and that of target node cannot be confirmed as the same. Herewith, handover between M-RN200 within the same mobile object is possible.

In this embodiment, the case, in which both Movement Condition and M-RN Group ID, described above, are notified, is explained as one example. One of them may be notified. Furthermore, in this embodiment, information for indicating whether the source node is mobile or not (hereinafter, “Node Type”) is further notified. However, Node Type is not necessary to be notified. Hereinafter, Node Type, M-RN Group ID and Movement Condition are referred to as “Mobile Node Information”.

Next, a handover procedure according to this embodiment is explained. FIG. 5 is an operation sequence diagram according to this embodiment.

As shown in FIG. 5, in step S110, UE300 accommodated to the source node transmits Measurement Report to the source node.

In step S120, the source node executes handover decision (Handover Decision) based on Measurement Report from UE300, and decides handover to the target node.

In step S130, the source node transmits HANDOVER REQUEST, which is a request message for handover execution, to the target node. HANDOVER REQUEST includes Mobile Node Information described above. HANDOVER REQUEST is described in detail later.

In step S140, the target node executes a handover admission decision (Handover Admission Control), based on HANDOVER REQUEST, from the source node. The handover admission decision is described in detail later.

In step S150, the target node transmits a message indicating an admission of HANDOVER REQUEST (HANDOVER REQUEST ACKNOWLEDGE), or a message indicating declining of HANDOVER REQUEST (HANDOVER PREPARATION FAILURE) to the source node.

Further processing (step S160), is the same as the existing handover procedure (e.g. referring non-patent literature 2).

Next, a flow of the handover admission decision is explained. FIG. 6 is a flow chart of the handover admission decision according to this embodiment.

As shown in FIG. 6, the target node retrieves Node Type included in HANDOVER REQUEST (that is Node Type of the source node), and Node Type of its own. Note, Node Type of its own is presumed to be memorized in the storage unit of its own.

In step S142, the target node confirms whether both Node Type of the source node and Node Type of its own are Mobile (mobile type) or not.

When neither Node Type of the source node nor Node Type of its own is mobile (i.e. fixed type) (step S142; YES), the target node executes a normal handover admission decision in step S148.

On the other hand, when at least one of Node Type of the source node and Node Type of the target node is Mobile (step S142; NO), the target node retrieves M-RN Group ID (i.e. M-RN Group ID of the source node) included in HANDOVER REQUEST and M-RN Group ID of its own. Note, M-RN Group ID of its own is presumed to be memorized in the storage unit of its own.

Then, in step S144, the target node confirms whether Node Type of the source node and Node Type of its own are both Mobile or not, and whether M-RN Group ID of the source node and M-RN Group ID of its own are identical or not.

Node Type of the source node and Node Type of its own are both Mobile, and M-RN Group ID of the source node and M-RN Group ID of its own are identical (step S144; YES), the target node executes the normal handover admission decision, in step S148.

On the other hand, when one of Node Type, of the source node and Node Type of its own, is not Mobile, and/or M-RN Group ID of the source node and M-RN Group ID of its own are not identical (step S144; NO), the target node further reads out Movement Condition included in HANDOVER REQUEST (i.e. Movement Condition of the source node) and Movement Condition of its own. Note, Movement Condition of its own is memorized in the storage unit.

And, in step S146, the target node confirms whether Movement Condition of the source node and Movement Condition of its own are both Stopping (in stop) or not.

When both Movement Condition of the source node and Movement Condition of its own are Stopping (in stop) (step S146; YES), the target node executes the normal handover admission decision in step S148.

On the other hand, at least one of Movement Condition of the source node and Movement Condition of its own is Moving (in motion) (step S146; NO), the target node decides that it is improper to execute handover, transmits HANDOVER PREPARATION FAILURE to the source node and finishes handover admission decision.

Note, in this flow, the target node executes plural decision processes based on Node Type, M-RN Group ID and Movement Condition, individually (step S142, step S144, step S146). The target node may execute one of the decision processes.

Next, HANDOVER REQUEST according to this embodiment is explained. FIG. 7 shows a configuration of HANDOVER REQUEST message according to this embodiment.

As shown in FIG. 7, HANDOVER REQUEST according to this embodiment is different from the existing HANDOVER REQUEST in a point of Mobile Node Information added as a new information element (IE). Note, please refer TS36.423 about details of the existing HANDOVER REQUEST.

FIG. 8 shows IE configuration of Mobile Node Information.

As shown in FIG. 8, Node Type is set “True” in case of Mobile, and is set “False” in case of Non-Mobile. M-RN Group ID is set unique ID for each M-RN Group. Movement Condition is set “True” in case of Moving and is set “False” in case of Stopping. Note, Mobile Node Information may further include a node ID of the source node or a cell ID of a source cell.

When eNB100 or RN200 receives Mobile Node Information IE, eNB100 or RN200 updates information stored in eNB100 or RN200, related to a cell indicated a source cell ID (or a node ID) included in Mobile Node Information, and executes the handover admission decision considering this information.

As described above, in this embodiment, when a mobile E-UTRAN Node exists, it is possible to change the handover control properly and dynamically, whether the node is in motion or in stop. In detail, a handover from E-UTRAN node in motion to E-UTRAN in stop and a handover from E-UTRAN node in stop to E-UTRAN node in motion are not admitted to execute. From this, a frequent occurrence of the Ping Pong handovers and a frequent occurrence of the handover failures can be avoided. Furthermore, an increase of a radio resource overhead, interference by an increase of transmission power due to improper connection E-UTRAN node and an increase of battery consumption can be avoided.

Moreover, in this embodiment, when UE is handed over from E-UTRAN node in mobile to other E-UTRAN node in mobile, the handover is admitted if preconfigured Group IDs between nodes are identical, and the handover is declined if preconfigured Group IDs are not identical. Thanks to this, the handover within the mobile object M-RN200 is possible.

In this way, the improper handover can be repressed when E-UTRAN node is in motion and the handover can be executed between the nodes, in which handover should be executed, for example M-RN set within the same mobile object, etc. And when the node stops, the normal handover can be executed. Furthermore, these handover controls in motion and in stop can be executed in dynamic and self-distributed. So the proper control according to situations is possible, and a manual operation is expected not to be required.

### [Modification of the First Embodiment]

In the first embodiment described above, the handover procedure using X2 interface is described, but the handover procedure using S1 interface may also be applied. In the handover procedure using S1 interface, the E-UTRAN node transmits HANDOVER REQUIRED to MME400 after handover (Handover Decision). And the E-UTRAN node transmits HANDOVER REQUEST ACKNOWLEDGE or HANDOVER FAILURE after the admission decision (Handover Admission Control).

FIG. 9 is an operation sequence figure of the handover procedure according to this embodiment.

As it is described in FIG. 9, UE300 accommodated to the source node transmits Measurement Report to the source node in step S110.

In step S120, the source node executes the handover decision (Handover Decision) and decides the handover to the target node based on the Measurement Report from UE300.

In step S130a, the source node transmits HANDOVER REQUIRED, which is a request message for executing the handover of UE300, to MME400. HANDOVER REQUIRED includes Mobile Node Information described above. Details of HANDOVER REQUIRED are described later.

In step S130b, MME400 transmits HANDOVER REQUIRED, which is a request message for executing the handover of UE300, to the target node, according to HANDOVER REQUIRED from the source node. HANDOVER REQUIRED includes Mobile Node Information described above. Details of HANDOVER REQUIRED are described later.

In step S140, the target node executes the handover admission decision (Handover Admission Control) based on HANDOVER REQUEST from MME400.

In step S150a, the target node transmits a message indicating the permission of HANDOVER REQUEST (HANDOVER REQUEST ACKNOWLEDGE) or a message indicating the decline of HANDOVER REQUEST (HANDOVER FAILURE) to MME400 according to a result of the handover admission decision.

The procedures hereafter (step S160a) are the same as the existing handover procedure (e.g. referring non patent literature 2).

Next, HANDOVER REQUIRED according to this embodiment is explained. FIG. 10 shows a configuration of HANDOVER REQUIRED message.

As it is described in FIG. 10, Mobile Node Information described above is added to HANDOVER REQUIRED according to this embodiment. This point is different from the existing HANDOVER REQUIRED. Note, please refer details of the existing HANDOVER Required in TS36.413.

When MME400 receives Mobile Node Information IE, MME400 forwards Mobile Node Information IE included in HANDOVER REQUEST to the target node.

Next, HANDOVER REQUEST according to this embodiment is explained. FIG. 11 shows HANDOVER REQUEST message according to this modification.

As it is described in FIG. 11, Mobile Node Information described above is added to HANDOVER REQUEST according to this embodiment. This point is different from the existing HANDOVER REQUEST. Note, please refer details of the existing HANDOVER Required in TS36.413.

When eNB100 or RN200 receives Mobile Node Information IE, eNB100 or RN200 updates information, stored in eNB100 or RN200, related to a cell indicated as source cell ID (or node ID) in Mobile Node Information IE. And eNB100 or RN200 executes the handover admission decision considering this information.

As it is explained above, according to this embodiment, a node, which has not established X2 interface yet or does not have X2 interface, can execute the admission decision (Handover Admission Control) considering Mobile Node Information, when the node has S1 interface.

### The Second Embodiment

The differences from the second embodiment and the first embodiment are mainly explained below.

In the first embodiment, Mobile Node Information is used for the admission decision (Handover Admission Control). On the other hand, in this embodiment, the target node notifies the source node of Mobile Node Information in advance, and Mobile Node Information is used for the handover decision (Handover Decision).

For example, X2 SETUP, which is a message for establishing X2 interface, and/or ENB CONFIGURATION UPDATE, which is a message for notifying the configuration modification of eNB/RN, can be applied for Mobile Node Information notification.

In this embodiment, E-UTRAN node notifies its M-RN Group ID and its Movement Condition to neighbor nodes. Note, E-UTRAN node checks its Movement Condition periodically, and if it is modified, E-UTRAN node notifies its Movement Condition again.

The nodes received these Mobile Node Information stores the information to the storage unit. And, it may update various configuration information (e.g. the modification of neighbor list, the modification of Measurement Configuration for UE300).

The source node executes Handover Decision based on Measurement Report from UE and Mobile Node Information above. As a result of Handover Decision, if the source node decides it is proper to execute handover, the source node transmits HANDOVER REQUEST to the target node. If the source node decides it is improper to execute handover, the source node does not take any further action.

Next, the handover procedure according to this embodiment is explained. FIG. 12 is an operation sequence figure according to this embodiment.

As it is described in FIG. 12, in step S210, the target node transmits X2 SETUP or ENB CONFIGURATION UPDATE to the source node. X2 SETUP or ENB CONFIGURATION UPDATE includes Mobile Node Information. Details of X2 SETUP and ENB CONFIGURATION UPDATE are described later. The source node, receiving Mobile Node Information, stores the information in its storage unit.

In step S220, UE300, accommodated to the source node, transmits Measurement Report to the source node.

In step S230, the source node executes the handover decision (Handover Decision) based on Measurement Report from UE300. Details of the handover decision are described later. In this case, it is presumed that the handover to the target node is decided.

In step S240, the source node transmits HANDOVER REQUEST, which is a request message for executing the handover of UE300, to the target node.

Further processing (step S250) is the same as the existing handover procedure (e.g. refer non patent literature 2).

Next, the handover flow according to this embodiment is explained. FIG. 13 is a handover decision flow chart according to this embodiment.

As it is shown in FIG. 13, in step S231, the source node decides the handover of UE300 and the target node.

In step S232, the source node reads out M-RN Group ID (i.e. M-RN Group ID of the target node) from the target node, included in X2 SETUP or ENB CONFIGURATION UPDATE, and M-RN Group ID of its own. Note, M-RN Group ID of its own is presumed to be stored in the storage unit.

In step S233, the source node checks whether M-RN Group ID of the target node and M-RN Group ID are matched or not.

If M-RN Group ID of the target node and M-RN Group ID are matched (step S233; YES), in step S236, the source node transmits HANDOVER REQUEST to the target node.

On the other hand, M-RN Group ID of the target node and M-RN Group ID are not matched (step S233; NO), in step S234, the source node reads out Movement Condition (i.e. Movement Condition of the target node) from the target node, included in X2 SETUP or ENB CONFIGURATION UPDATE, and Movement Condition of its own. Note, Movement Condition of its own is presumed to be stored in the storage unit.

And, in step S235, the source node checks whether both Movement Condition of the target node and Movement Condition of its own are not in mobile (i.e. Stopping).

If both Movement Condition of the target node and Movement Condition of its own are Stopping (step S235; YES), in step S236, the source node transmits HANDOVER REQUEST to the target node.

On the other hand, if at least one of Movement Condition of the target node and Movement Condition of its own is Moving (step S235; NO), in step S237, the source node decides it is improper to execute handover, does not transmit HANDOVER REQUEST to the target node and finish the decision of the handover.

Note, in this flow, the source node executes the plural of the decision processes (step S233, step S235), based on M-RN Group ID and Movement Condition, but the source node may execute at least either one of the processes.

Next, X2 SETUP according to this embodiment is explained. FIG. 14 shows a configuration of X2 SETUP message according to this embodiment.

As it is shown in FIG. 14, X2 SETUP according to this embodiment is different from the existing X2 SETUP in a point that Mobile Node Information is added as a new IE. Note, please refer TS36.423 about details of the existing X2 SETUP. When eNB100 or RN200 receives Mobile Node Information IE, eNB100 or RN200 updates information, stored in eNB100 or RN200, related to a cell indicated as source cell ID (or node ID) in Mobile Node Information IE. Next, ENB CONFIGURATION UPDATE according to this embodiment is explained. FIG. 15 is a message configuration of ENB CONFIGURATION UPDATE according to this embodiment.

As it is described in FIG. 15, ENB CONFIGURATION UPDATE, according to this embodiment, is different from the existing ENB CONFIGURATION UPDATE in a point that Mobile Node Information is added as a new IE. Note, please refer TS36.423 about details of the existing ENB CONFIGURATION UPDATE. When eNB100 or RN200 receives Mobile Node Information IE, eNB100 or RN200 updates information, stored in eNB100 or RN200, related to a cell indicated as source cell ID (or node ID) in Mobile Node Information IE.

As it is explained above, according to this embodiment, the same effect of the first embodiment can be achieved.

### [The First Modification of the Second Embodiment]

In the second embodiment above, the handover procedure using X2 interface is described. However, the handover procedure using S1 interface, being similar to the modification of the first embodiment, may also be applied.

FIG. 16 is an operation sequence figure of the handover procedure. As it is shown in FIG. 16, the source node transmits HANDOVER REQUIRED (step S240a) to MME, after Handover Decision. This point is different from the second embodiment.

### [The Second Modification of the Second Embodiment]

In the second embodiment above, an example that Mobile Node Information is notified by X2 SETUP or ENB CONFIGURATION UPDATE, which is transmits and receives on X2 interface, is explained. In contrast, Mobile Node Information is notified by messages transmitted and received on S1 interface in this modification.

Next, the handover procedure according to this embodiment is explained. FIG. 17 is an operation sequence figure of the handover procedure according to this embodiment.

As it is shown in FIG. 17, the target node transmits eNB CONFIGURATION TRANSFER to MME400 in order to inform the configuration modification related to SON. eNB CONFIGURATION TRANSFER includes Mobile Node Information. Details of eNB CONFIGURATION TRANSFER are described later.

In step S210a, MME400 transmits MME CONFIGURATION TRANSFER, including Mobile Node Information from the target node, to the source node. Details of MME CONFIGURATION TRANSFER are described later

In step S220, UE300 accommodated to source node transmits Measurement Report to source node.

In step S230, the source node executes the handover decision (Handover Decision) based on Measurement Report from UE300. Details of the handover decision are described later. In this case, it is presumed that the handover to the target node is decided.

In step S240, the source nodes transmits HANDOVER REQUIRED, which is a request message for executing handover of UE300, to MME400.

The procedures hereafter (step S250) are the same as the existing handover procedure (e.g. referring non patent literature 2).

Next, eNB CONFIGURATION TRANSFER according to this modification is explained. FIG. 18 shows a message configuration of eNB CONFIGURATION TRANSFER according to this modification.

As it is shown in FIG. 18, eNB CONFIGURATION TRANSFER according to this modification is added Mobile Node Information Transfer, including Mobile Node Information, source cell ID and target cell ID, as a new IE. This point is different from the existing eNB CONFIGURATION TRANSFER. Note, please refer details of the existing eNB CONFIGURATION TRANSFER in TS36.413.

When MME400 receives Mobile Node Information Transfer IE, MME400 forwards Mobile Node Information Transfer IE to the cell indicated by the target cell ID included in Mobile Node Information Transfer IE.

Next, MME CONFIGURATION TRANSFER according to this modification is explained. FIG. 19 shows a message configuration of MME CONFIGURATION TRANSFER according to this modification.

As it is shown in FIG. 19, MME CONFIGURATION TRANSFER according to this modification is added Mobile Node Information Transfer IE, as anew IE. This point is different from the existing MME CONFIGURATION TRANSFER.

Note, please refer details of the existing MME CONFIGURATION TRANSFER in TS36.413.

When eNB100 or RN200 receives Mobile Node Information IE, eNB100 or RN200 updates information, stored in eNB100 or RN200, related to a cell indicated as source cell ID (or node ID) in Mobile Node Information IE.

As it is explained above, according to this modification, a node, which has not established X2 interface yet or does not have X2 interface, can execute the handover decision (Handover Admission Control) considering Mobile Node Information, when the node has S1 interface.

### The Third Embodiment

The third embodiment is explained mainly on the difference from the first embodiment and the second embodiment, below.

In this embodiment, Mobile Node Information is notified from the target node to the source node in advance. Mobile Node Information is used for controlling configuration information of a measurement function (UE measurement) in UE300. For example, the configuration information is a list of cells excluding from UE Measurement (Black Listed Cell), Black List. Black Listed Cell is excluded from target cells of UE Measurement and cell reselection candidate cells.

Next, a handover procedure according to this embodiment is explained. FIG. 20 is an operation sequence figure of the handover procedure according to this embodiment.

As it is described in FIG. 20, in step S310, the target node transmits X2 SETUP or ENB CONFIGURATION UPDATE to the source node. X2 SETUP or ENB CONFIGURATION UPDATE includes Mobile Node Information as with the second embodiment. Or, eNB CONFIGURATION TRANSFER and MME CONFIGURATION TRANSFER may be applied as with the second modification. The source node, receiving Mobile Node Information, stores the information to its storage unit.

In step S320, the source node executes a modification decision of Black List (Black List Modify Decision). Details of the modification decision of Black List are described later.

When the source node decides that it is proper to modify the configuration of UE Measurement as a result of the modification decision of Black List, the source node transmits RRCConnectionReconfiguration to UE300 in step S330. When the source node decides that it is improper to make handover, the source node does not take any further action.

When UE300 receives RRCConnectionReconfiguration, UE transmits RRCConnectionReconfigurationComplete in step S340.

In step S350, UE300 reports a measurement value excluding Black Listed Cell in Measurement Report after receiving RRCConnectionReconfiguration.

In step S350, the source node executes the handover decision, based on the measurement value excluding Black Listed Cell. Thanks to this, it is possible to execute proper handover control, as Black Listed Cell is excluded from the handover target. Note, further processing is the same as the existing handover procedure (e.g. referring non-patent literature 2).

Next, the modification decision of Black List according to this embodiment is explained. FIG. 21 is a flow chart of the modification decision of Black List according to this embodiment.

As it is shown in FIG. 21, in step S321, the source node reads out M-RN Group ID (i.e. M-RN Group ID of the target node) from the target node, included in X2 SETUP or ENB CONFIGURATION UPDATE, and M-RN Group ID of its own. Note, M-RN Group ID of its own is presumed to be stored in the storage unit.

And, in step S322, the source node checks whether M-RN Group ID of the target node and M-RN Group ID are matched or not.

If M-RN Group ID of the target node and M-RN Group ID are matched (step S322; YES), a process proceeds to step S326.

On the other hand, M-RN Group ID of the target node and M-RN Group ID are not matched (step S322; NO), in step S323, the source node reads out Movement Condition (i.e. Movement Condition of the target node) from the target node, included in X2 SETUP or ENB CONFIGURATION UPDATE, and Movement Condition of its own. Note, Movement Condition of its own is presumed to be stored in the storage unit.

And, in step S324, the source node checks whether both Movement Condition of the target node and Movement Condition of its own are not in mobile (i.e. Stopping).

If both Movement Condition of the target node and Movement Condition of its own are Stopping (step S324; YES), the process proceeds to step S326.

On the other hand, if at least one of Movement Condition of the target node and Movement Condition of its own is Moving (step S324; NO), in step S325, the source node decides it is improper to execute handover, adds a cell ID corresponding to the target node to Black List, and notify UE300.

Meanwhile, in step S326, the source node checks whether the cell ID corresponding to the target node is included or not. If it is included (step S326; YES), in step S327, the source node deletes the cell ID corresponding to the target node and notifies UE, If it is not included (step S326; No), in step S328, the source node does not do anything (no further action).

Note, in this flow, the source node executes the plural of the decision processes (step S322, step S324), based on M-RN Group ID and Movement Condition, but the source node may execute at least either one of the processes.

As it is explained, according to this embodiment, it is possible to get the similar effect to the first embodiment and the second embodiment.

### The Fourth Embodiment

The fourth embodiment is explained mainly on the difference from the first embodiment to the third embodiment, below.

The first embodiment to the third embodiment described above, is targeted for handover control. In contrast, in this embodiment, a mobility control, when UE300 is RRC_IDLE, is targeted. It means a cell reselection control (Cell Reselection) is targeted.

Next, the cell reselection procedure according to this embodiment is explained. FIG. 22 is an operation sequence figure of the cell reselection procedure according to this embodiment. In this embodiment, the node corresponding to a cell UE camping-on is the source node and the node corresponding to the re selection candidate cell is the target node.

As it is shown in FIG. 22, in step S410, the target node transmits X2 SETUP or ENB CONFIGURATION UPDATE to the source node. X2 SETUP or ENB CONFIGURATION UPDATE includes Mobile Node Information, as with the second embodiment and the third embodiment. Or, as with the modification of the second embodiment, eNB CONFIGURATION TRANSFER or MME CONFIGURATION TRANSFER may be applied. The source node, receiving Mobile Node Information, stores the information to its storage unit.

In step S420, the source node executes the modification decision of Black List (Black List Modify Decision) based on Mobile Node Information, as with the third embodiment.

The source node decides that it is proper to modify system information, as a result of the modification decision of Black List, the source node transmits PAGING or System Information Block (SIB) Type1 including a modification notification of system information, via broadcast, in step S430.

Next, in step S440, the source node notifies the modification information of Black Listed Cell by SIB Type4 or 5.

In step S450, UE300 receives Type4 or 5 including the modification information of Black Listed Cell, and UE300 executes a cell reselection process excluding Black Listed Cell from the cell reselection candidates. Thanks to this, the proper cell reselection control is possible, as Black Listed Cell is excluded from the candidates at the cell reselection.

### Other Embodiments

As described above, the present invention is described by each embodiment, but it is not to be understood that the description and the figures comprising this disclosure should not be understand to limiting the present invention. From this disclosure, the various alternatives, embodiment and operation techniques are clarified for skilled persons in the art.

Mobile Node Information described above may be omitted partially at least. FIG. 23 shows Mobile Node Information according to other embodiments. As it is described in FIG. 23, when M-RN Group ID is zero, M-RN Group ID is zero, it means that it is recognized as a mode, in which barring of handover and cell reselection, is not required. Accordingly, Node Type and Movement Condition are identified as False. When M-RN Group ID is not zero, M-RN Group ID is assigned ID and is identified as a mode, in which barring of handover and cell reselection, is required. Accordingly, Node Type and Movement Condition are identified as True. In this way, an information element of 3 piece of information can represent by one parameter.

In each embodiment described above, M-RN is explained as an example of the mobile type node, but eNB may be the mobile type.

In each embodiment described above, the communication system configured based on LTE-Advance is explained as an example. However, the present invention may be applied for not only LTE-Advance but the communication system supporting the mobile type node.

### INDUSTRIAL APPLICABILITY

As described above, as the communication system, the radio communication node and communication control method according to this invention can execute UE mobility control properly, even when M-RN is introduced, they are useful for a radio communication such as mobile communication.

1. A communication system provided with a user equipment, a radio access network being capable of communicating with the user equipment, and the radio access network including a mobile radio communication node, the communication system comprising:
a first radio communication node included in the radio access network,
a second radio communication node included in the radio access network,
the first radio communication node transmits node information for a mobility control of the user equipment,
the second radio communication node receives the node information, wherein
the node information includes at least one of
information indicating whether the first radio communication node is mobile or not,
information indicating a mobile radio communication group, to which the first radio communication node belongs, when the first radio communication node is mobile and
information indicating a mobility status of the first radio communication node.

2. The communication system according to claim 1 further comprising:
a core network connected to the radio access network, wherein
the second radio communication node receives the node information from the first radio communication node via the core network.

3. The communication system according to claim 1 further comprising:
the first communication node transmits a request for handover of the user equipment, accommodated to the first radio communication node,
the second radio communication node executes a decision whether the request received is admitted or not, wherein
the node information is used for the decision at the second radio communication node.

4. The communication system according to claim 1 further comprising:
when the second radio communication node receives a report regarding a measurement result of the received signal status at the user equipment from the user equipment accommodated by the second radio communication node, the second radio communication node executes a decision of handover based on the report received, wherein
the node information is used for the decision at the second radio communication node.

5. The communication system according to claim 1 further comprising:
the second radio communication node transmits information for a measurement control for measuring a received signal status at the user equipment to the user equipment accommodated by the second radio communication node, wherein
the node information is used for the measurement control at the second radio communication node.

6. The communication system according to claim 1 further comprising:
the second radio communication node transmits information for a cell reselection control by broadcast, wherein,
the node information is used for the cell reselection control at the second radio communication node.

7. A radio communication node in a communication system, the communication system provided with a user equipment, a radio access network being capable of communicating with the user equipment, and the radio access network including a mobile radio communication node, the radio communication node comprising:
a transmission unit configured to transmit node information for a mobility control of the user equipment to another radio communication node included in the radio access network, wherein
the node information includes at least one of
information indicating whether the radio communication node is mobile or not,
information indicating a mobile radio communication group, to which the radio communication node belongs, when the radio communication node is mobile and
information indicating a mobility status of the radio communication node.

8. A radio communication node in a communication system, the communication system provided with a user equipment, a radio access network being capable of communicating with the user equipment, and the radio access network including a mobile radio communication node, the radio communication node comprising:
a receiving unit configured to receive node information transmitted by another radio communication node included in the radio access network, and the node information is for a mobility control of the user equipment, wherein
the node information includes at least one of
information indicating whether the another radio communication node is mobile or not,
information indicating a mobile radio communication group, to which the another radio communication node belongs, when the another radio communication node is mobile and
information indicating a mobility status of the another radio communication node.

9. A communication control method in a communication system, the communication system provided with a user equipment, a radio access network being capable of communicating with the user equipment, and the radio access network including a mobile radio communication node, the communication system comprising:
a step of transmitting, by a first radio communication node included in the radio access network, node information for a mobility control of the user equipment,
a step of receiving, by the second radio communication node included in the radio access network, the node information, wherein
the node information includes at least one of
information indicating whether the first radio communication node is mobile or not,
information indicating a mobile radio communication group, to which the first radio communication node belongs, when the first radio communication node is mobile and
information indicating a mobility status of the first radio communication node.
